(19) United States
(12) Patent Application Publication
(10) Pub. No.: US 2023/0068077 A1
(43) Pub. Date: Mar. 2, 2023

(54) DOCKING SMART LOCKERS AND AUTONOMOUS DELIVERY SYSTEMS, METHODS, AND DEVICES

(71) Applicant: Smiota Inc., Fremont, CA (US)

(72) Inventor: Manjunatha Kashi, San Jose, CA (US)

(21) Appl. No.: 17/895,064

(22) Filed: Aug. 25, 2022

Related U.S. Application Data
(60) Provisional application No. 63/236,916, filed on Aug. 25, 2021.

(51) Int. Cl. G06Q 10/08; G07C 9/00

(52) U.S. Cl. CPC G06Q 10/08355; G07C 9/00182

(57) ABSTRACT

Disclosed herein are autonomous delivery vehicles devices, systems and methods. The autonomous delivery vehicle devices are mounted with smart locker banks to facilitate the automated delivery of packages stored within compartments of the smart locker banks.

### CROSS-REFERENCE TO RELATED APPLICATIONS

This application claims priority to U.S. Provisional Patent Application No. 63/236,916 titled, “Docking Smart Lockers and Autonomous Delivery Systems, Methods, and Devices” filed on Aug. 25, 2021. The entirety of the disclosures of the aforementioned application is considered part of, and is incorporated by reference in, the disclosure of this application.

### FIELD OF THE INVENTION

This invention relates to systems and autonomous vehicle devices configured as a docking unit for smart locker devices communicatively coupled to smart locker networks. The invention also relates to methods for loading smart locker devices onto autonomous vehicles and methods for delivering and receiving smart lockers via the autonomous vehicles.

### BACKGROUND

Currently, last mile delivery has received notable attention, specifically with respect to parcel deliveries. However, there are several challenges associated with current delivery modalities. For instance, typically couriers deliver packages along pre-defined routes regardless of the number of packages to be delivered on a given day along such route. As such, the dispatch of package deliveries along a pre-defined route is inefficient. Furthermore, couriers work according to shifts and such shifts are often scheduled weeks in advance. Accordingly, such fixed schedules create work rigidities that result in pre-defined times of the day to load packages into a vehicle or the specific sets of routes that can be implemented during such schedule.

Other challenges and issues include challenges associated with delivery scheduling mechanisms, package loading mechanisms, and delivery route determinations. Given the prevalence of such issues there is a need for new solutions and technologies to solve such challenges and inefficiencies.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein are systems, devices, apparatuses, and methods that employ components to facilitate filtered smoking.

According to a non-limiting embodiment, disclosed is an automated delivery system comprising an ordering module configured to receive, via one or more processor, delivery orders corresponding to an order identifier. The automated delivery system can also include a fulfillment module configured to assign, via the one or more processor, delivery fulfillment data to the order identifier, wherein the delivery fulfillment data comprises at least one of a customer name, customer delivery address, destination location coordinates, or customer contact information. Furthermore, the automated delivery system can include a route generation module configured to generate, via the one or more processor; a delivery route for a set of customer orders that satisfies a minimal threshold travel time.

In another aspect, the automated delivery system can include a procurement module configured to generate, via the one or more processor, a set of target packages corresponding to the set of customer orders for storage within a portable smart locker bank. In yet another aspect, the automated delivery system can include a route implementation module configured to provision, via the one or more processor, the delivery route for an autonomous chassis configured to receive the portable smart locker bank.

### BRIEF DESCRIPTION OF THE DRAWINGS

FIG. 1A illustrates an overview of a representative environment in which a cloud implemented network orchestrates operations of an autonomous chassis and/or integrated smart locker component in accordance with one or more embodiments described herein.

FIG. 1B illustrates a diagram of a non-limiting, example autonomous delivery vehicle configured to integrate with smart locker devices and employ package delivery operations in accordance with one or more embodiments described herein.

FIG. 2 illustrates a diagram of a non-limiting example smart locker device configured to integrate with the autonomous delivery vehicle in accordance with one or more embodiments described herein.

FIG. 3A illustrates a diagram of a non-limiting, example autonomous delivery vehicle integrated with a smart locker device configured for such integration in accordance with one or more embodiments described herein.

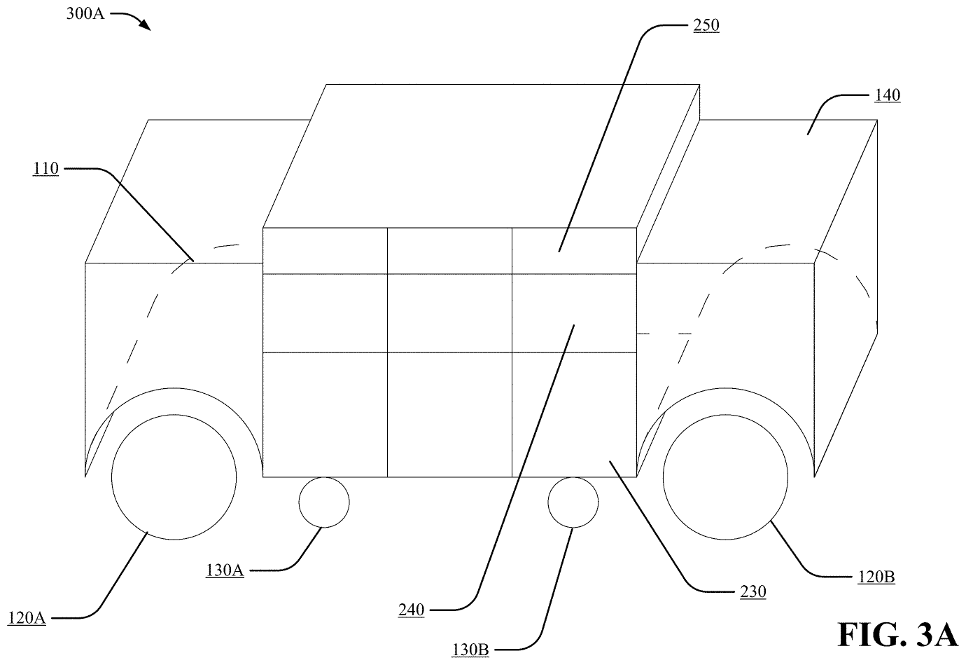

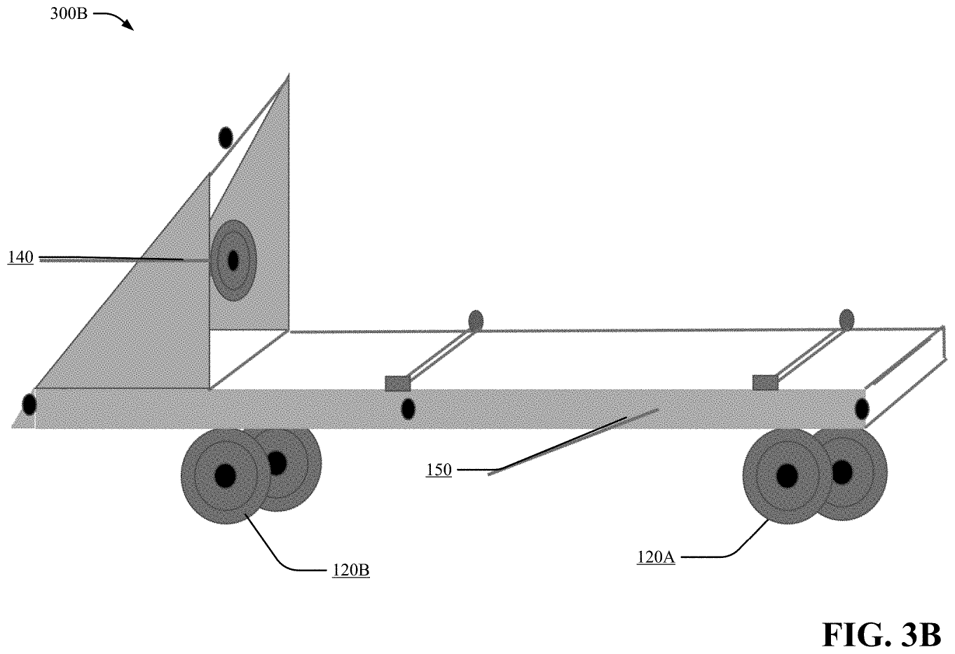

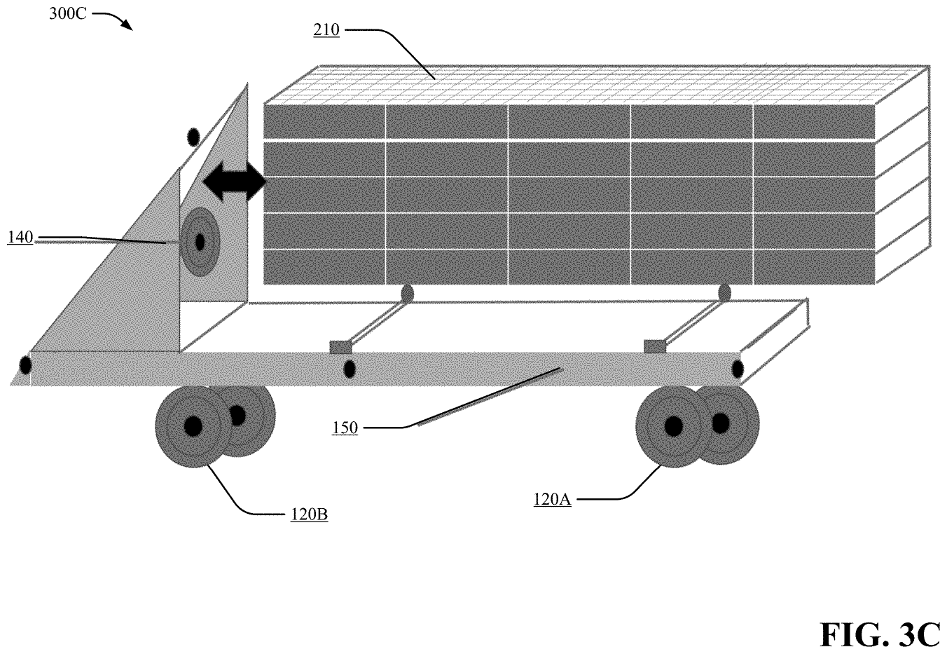

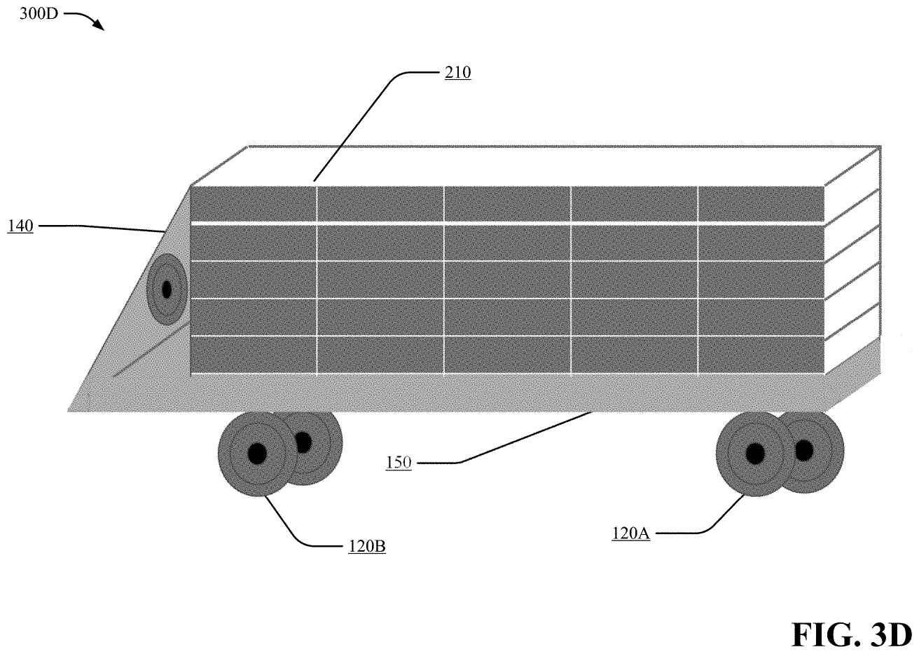

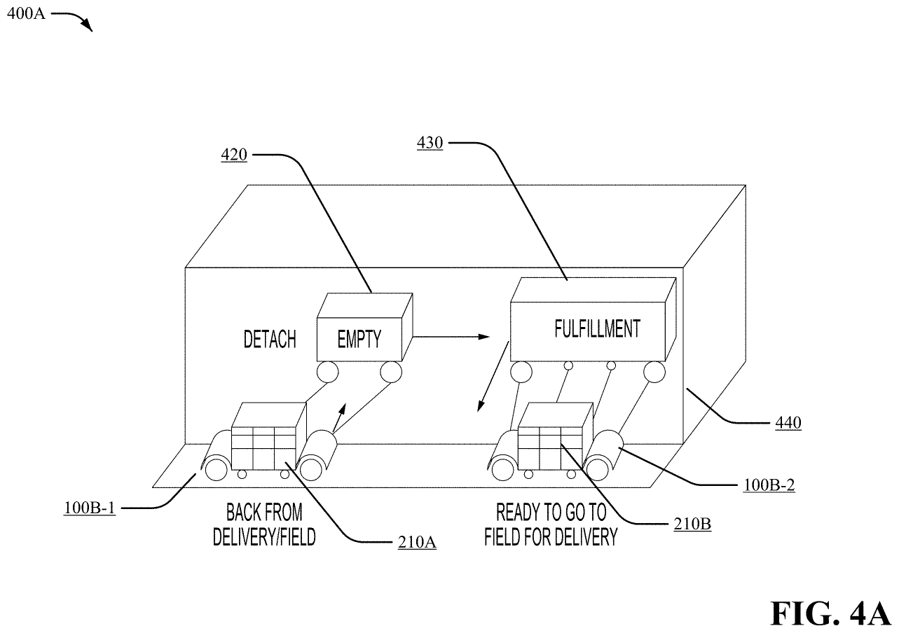

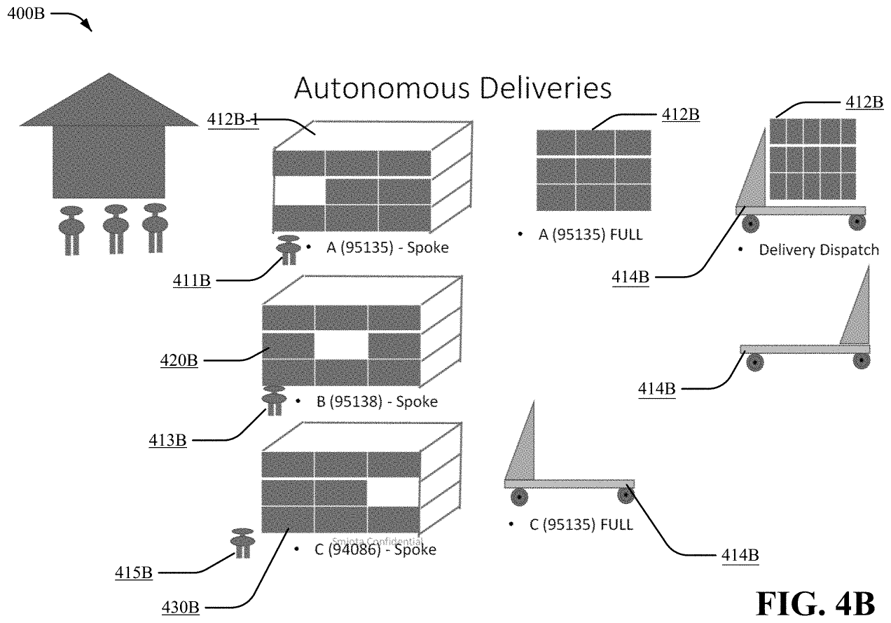

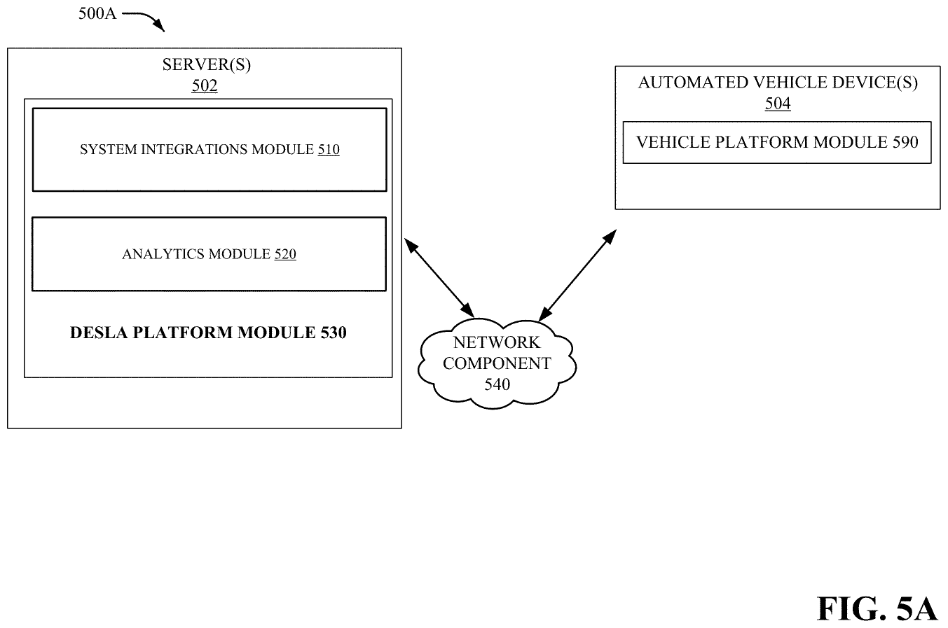

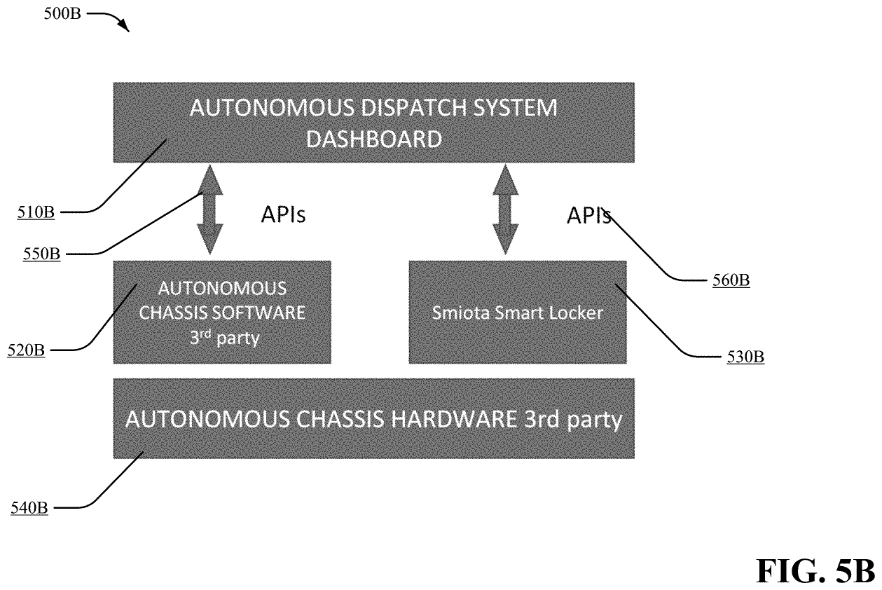

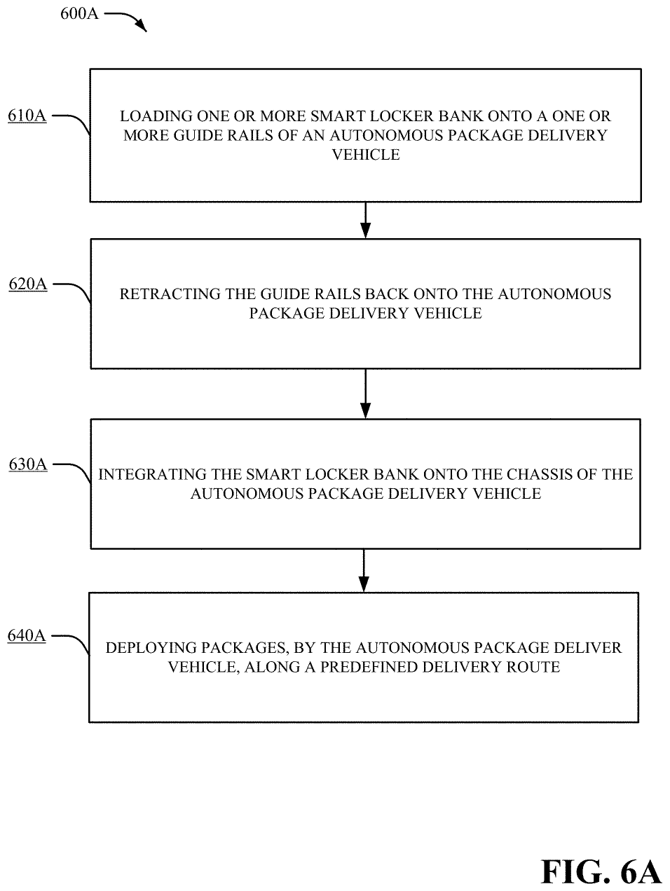

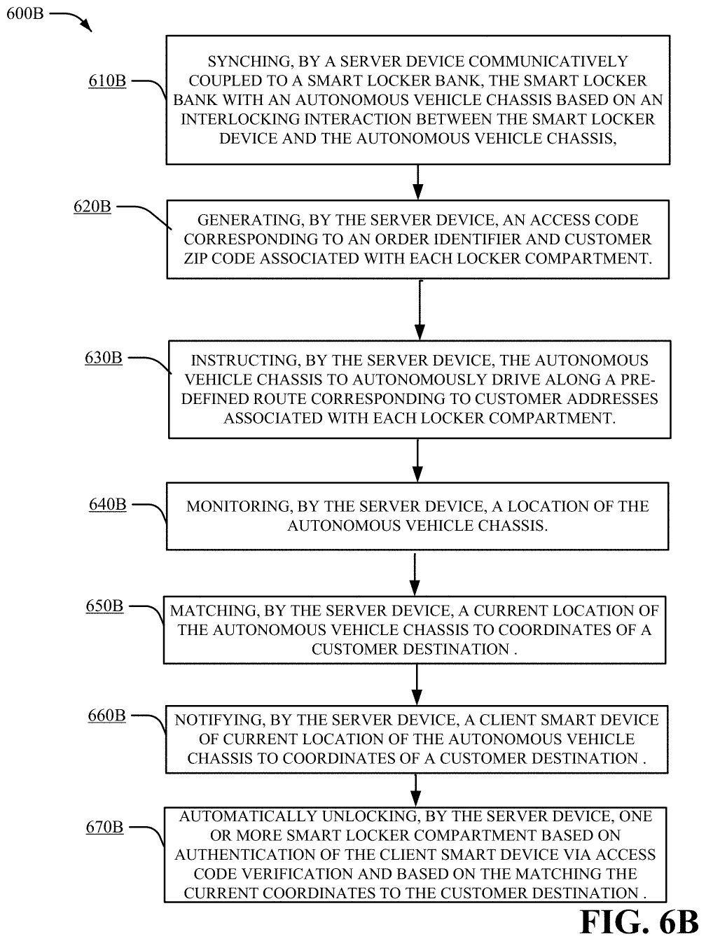

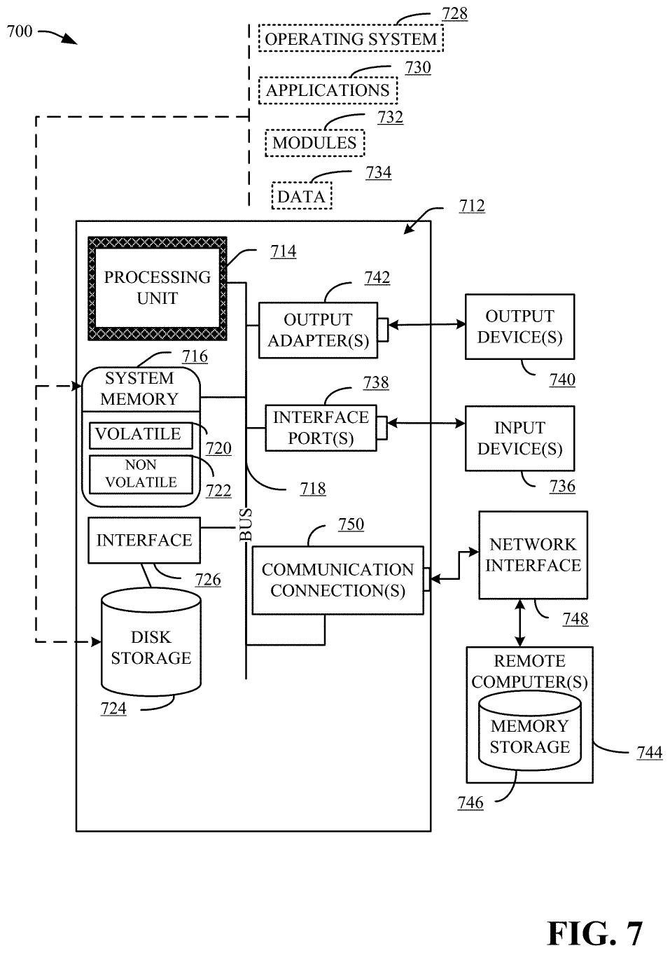

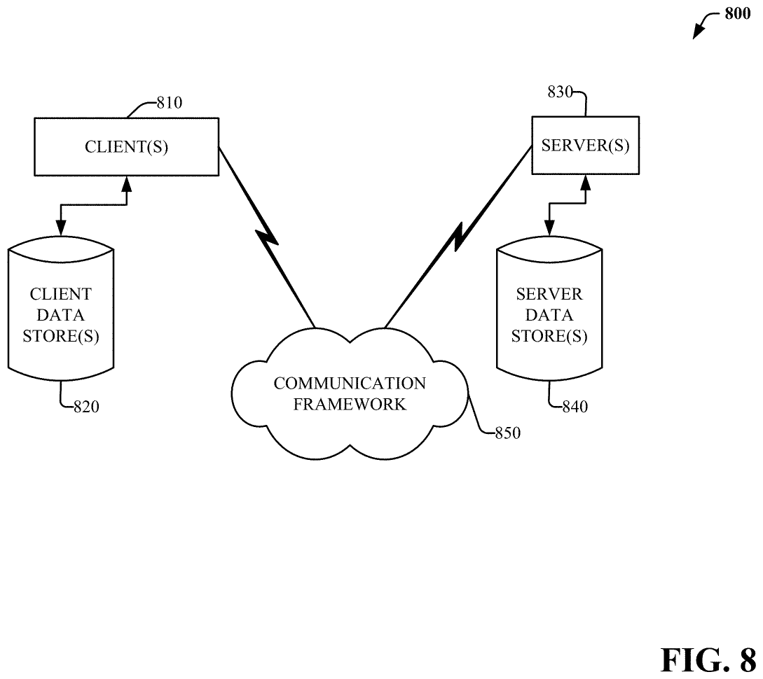

Turning now to FIG. 3B, illustrated is a diagram of a non-limiting, example autonomous delivery vehicle 300B integrated with a smart locker device configured for such integration in accordance with one or more embodiments described herein.

Turning now to FIG. 3C, illustrated is a diagram of a non-limiting, example autonomous delivery vehicle 300C integrated with a smart locker device configured for such integration in accordance with one or more embodiments described herein.

Turning now to FIG. 3D, illustrated is a diagram of a non-limiting, example autonomous delivery vehicle 300D integrated with a smart locker device configured for such integration in accordance with one or more embodiments described herein.

FIG. 4A illustrates a diagram of a non-limiting, example autonomous delivery vehicle fulfillment system configured to enable efficient package and smart locker device fulfillment operations in connection with the autonomous delivery vehicle in accordance with one or more embodiments described herein.

Turning now to FIG. 4B, illustrated is a diagram of a non-limiting, example autonomous delivery vehicle enabled package delivery system 400B configured to enable efficient package delivery in accordance with one or more embodiments described herein.

FIG. 5A illustrates a block diagram of a non-limiting, example system for enable efficient package and smart locker device fulfillment operations in connection with the autonomous delivery vehicle in accordance with one or more embodiments described herein.

FIG. 5B, illustrates is a block diagram of a non-limiting, example system for dispatching one or more autonomous delivery vehicle in accordance with one or more embodiments described herein.

FIG. 6A illustrates a block diagram of a non-limiting method of loading smart locker banks onto an autonomous delivery vehicle in accordance with one or more embodiments described herein.

FIG. 6B illustrates a block diagram of a non-limiting method of deploying packages by an autonomous delivery vehicle in accordance with one or more embodiments described herein.

FIG. 7 illustrates a flow diagram of an example, non-limiting operating environment in which one or more embodiments described herein can be facilitates.

FIG. 8 illustrates a flow diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Disclosed here are several non-limiting embodiments of autonomous vehicle devices configured to integrate (e.g., via a mounting mechanism) one or more smart locker device (e.g., smart locker banks comprising several compartments) onto the chassis of the autonomous vehicle. In some embodiments, autonomous vehicles affixed to smart lockers are disclosed and in other non-limiting embodiments autonomous vehicles with removable smart lockers are disclosed. Furthermore, the autonomous vehicle can perform package delivery operations. For instance, the autonomous vehicle can be configured with a body portion that exposes a chassis and a flat surface configured to interlock with a set of smart locker banks.

The smart locker banks can comprise a series of compartments connected to compartment doors configured with locking mechanisms that allow access to authorized users for storing, depositing, and/or retrieving packages. The smart locker devices can be communicatively coupled to a series of applications and devices such as an application configured to control the locker operations, a detection application configured to detect the presence of a locker user (e.g., using a wireless personal area network technology), an application to manage package inventory stored within smart locker compartments, a cloud computing service infrastructure that can include application service modules (e.g., mailroom application, locker application, service room application, inventory application, package room application, service level agreement management application, recipient application, etc.), application frameworks (e.g., logging, monitoring, role-based security, notifications, configurations, single-sign on (SSO), reporting and analytics, auditing and other such frameworks), storage components (e.g., persistent storage, replication storage), and other such applications and devices.

The smart locker devices are supported by an intricate framework of systems and devices that endow the smart locker devices with a robust set of capabilities. As such, the smart locker devices are further implemented as an element of an autonomous package delivery vehicle and autonomous delivery system. Accordingly, disclosed herein is an autonomous mail and package delivery vehicle integrated with a smart locker device where such integrated device can execute package delivery operations. The autonomous delivery vehicle is configured to receive smart locker banks that integrate onto the vehicle chassis, where the smart locker banks are pre-loaded with packages within the smart locker compartments. The autonomous delivery vehicle is subsequently able to deliver packages in accordance with an optimal delivery schedule and route. The autonomous package delivery vehicle embodiments disclosed herein enable the implementation of efficient package delivery scheduling mechanisms, package loading mechanisms, and delivery route determinations.

Also disclosed herein are various non-limiting embodiments of smart locker devices configured to integrate with an autonomous vehicle chassis including, but not limited to smart locker devices comprising hardware elements, executable modules, and interconnected computing devices that enables secure storage, delivery and/or retrieval of packages or other articles within the smart locker devices; system embodiments for executing instruction (e.g., by a processor where the instructions are stored in a memory) in connection with smart locker devices to enable execution of automated operations corresponding to the smart locker devices such as storing, delivery, and/or retrieval of parcels; and non-limiting example methods for securely storing, sending and/or retrieving parcels or other items using one or more smart locker device whether integrated with the autonomous vehicle chassis or as a stand-alone smart locker bank (e.g., deployed by an autonomous vehicle chassis to a target destination or routed using an autonomous guiding system and wheels of the smart locker device).

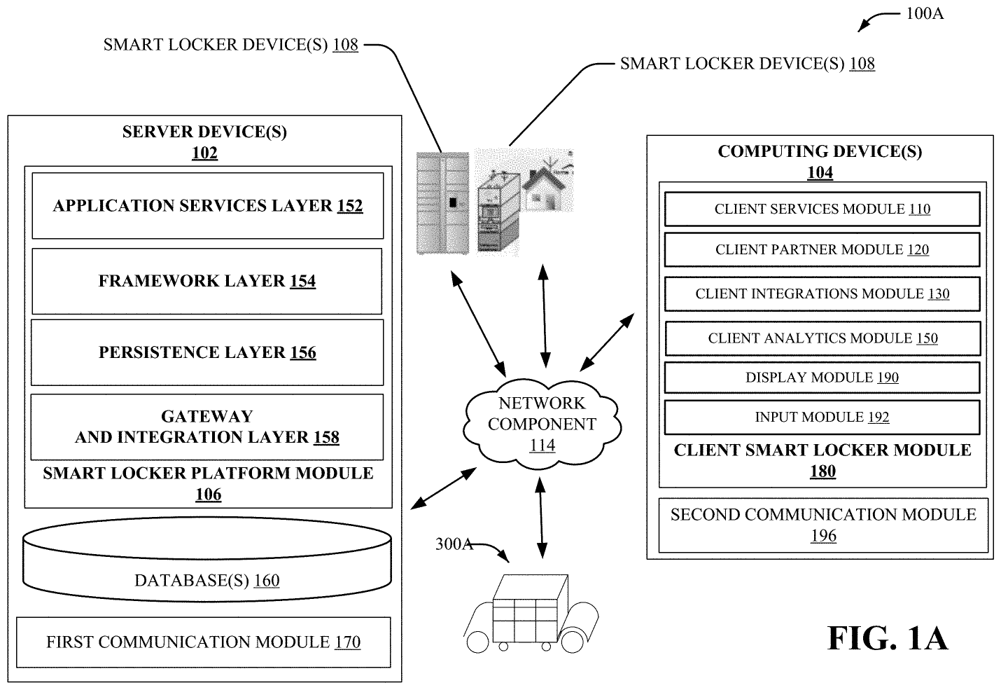

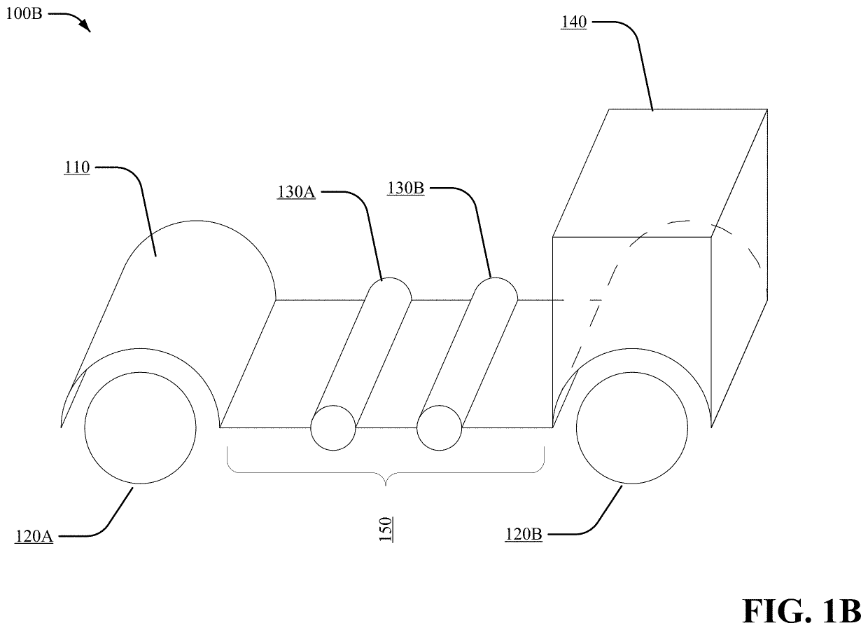

Turning now to FIG. 1A, illustrated is an overview of a representative environment 100 in which a cloud implemented network orchestrates operations of an autonomous chassis and/or integrated smart locker component in accordance with one or more embodiments described herein. In non-limiting embodiments, example environments can include servers, computing devices, smart locker devices, autonomous vehicle chassis, autonomous smart locker vehicles, cloud communication mechanisms and processing systems configured to perform a range of operations associated with the smart locker devices. In other aspects, the environment can be configured to integrate application modules, integration modules to execute any of a range of mailroom, smart locker, inventory, and package room operations.

In an aspect, non-limiting example environment 100A can include one or more server device(s) 102, one or more smart locker device(s) 108, and one or more computing device(s) 104. In an aspect, smart locker device(s) 108 can be configured as an assortment of one or more locker compartments connected physically (e.g., via hinge mechanism) and communicatively coupled to one or more server device(s) 102. In an aspect, the smart locker device(s) 108 can be configured to attach or integrate onto an autonomous vehicle device chassis or permanently affix as a component of a smart locker autonomous vehicle. The smart locker device(s) 108 can comprise hardware components such as one or more mainboard (e.g., Bluetooth enabled mainboard), circuit breaker, power module, lock control board (e.g., to control the compartment and door locking mechanisms), lock components (e.g., electronic locks) configured to allow locking of the doors affixed to respective compartment, infrared sensors (e.g., to detect the presence or absence of packages), scanner component, power outlet component, socket components (e.g., USB), ports (e.g., 110V), power outlet (e.g., 110V), radio-frequency integrated circuit (RFIC) readers, bar code scanners (e.g., for package label reading), screws, cables, varied connectivity (e.g., ethernet, Wi-Fi, LTE, etc.) and other such components. In an aspect smart locker device(s) can be smart locker banks configured to interlock with, dock and undock from, an autonomous vehicle such as an autonomous vehicle chassis. For instance, autonomous delivery vehicle 300A can be configured as a chassis that interlocks with one or more smart locker banks (e.g., smart locker device(s) 108).

Furthermore, smart locker device(s) 108 can be configured to comprise varied materials (e.g., cold rolled sheets), surface treatments (e.g., powder coatings), color options, a range of structures (e.g., varied number of compartments, doors, compartment sizes, etc.), a range of packaging (e.g., wood casings), and expansion integrations. Furthermore, smart locker device(s) 108 can be configured to execute various operations such as refrigeration, heating, sanitization, de-contamination, and other such operations. For instance, a smart locker device(s) 108 with freezer capability can be configured to store, maintain, and provide access to perishable items such as produce and grocery products. In an aspect, such freezer configured smart locker device(s) 108 can comprise additional components such as additional power supplies, trip switches, cables, compressors, and other such components. Furthermore, the smart locker device(s) 108 can be configured to operate at temperatures between 40 degrees and 70 degrees Fahrenheit and thus be utilized as an indoor device. Furthermore, in an aspect, the smart locker device(s) 108 can be configured to maintain temperatures within compartments of between 33.8 degrees to 42.8 degrees Fahrenheit for refrigeration capabilities and between −1.4 degrees Fahrenheit to −7.6 degrees Fahrenheit for freezer capabilities.

In other aspects, smart locker device(s) 108 can be configured to allow for an automatic open door mechanism and/or manual compartment door opening mechanism. Furthermore, refrigeration configured smart locker device(s) 108 can comprise freezer compartments, refrigerant, insulation layers (e.g., polyurethane), varied insulation thickness (e.g., 100 mm), air cooling mechanisms (e.g., forced air mechanisms), controllers (e.g., digital), and/or a compressor component mounted in a range of positions (e.g., top of the unit, etc.). Furthermore, in some instances, smart locker device(s) 108 can comprise varied door types and sizes. For instance, a smart locker device(s) 108 can include a 17 door model (e.g., 13 small compartments, 2 medium, 2 large, etc.), 13 door model (e.g., 5 small, 6 medium, 2 large, etc.), 8 door model, 5 door model, and other such configurations.

In one or more non-limiting embodiment, smart locker device(s) 108 can comprise physical components comprising at least one or more of the following: compartments configured as package receptacles, user interface such as a touch screen or display monitor, compartment doors to provide access to the smart locker compartment, hinges configured to allow an opening and/or closing of the compartment door, locking components (e.g., resistant locks, high security locks, electronic locks, biometric locks, etc.), locker banks of varying shapes and/or sizes and/or dimensions (e.g., assortment of compartment sizes, add on locker bank portions), refrigeration smart lockers (e.g., insulation components, refrigerant components, etc.), heated smart lockers, sensor enabled components of such smart locker device(s) 108 (e.g., temperature sensor, weather sensor, humidity sensor, heat sensor, light sensor, pressure sensors, optical sensor configured for package detection, light beam obstruction and un-obstruction event driven detectors, package measurement sensors via light beams, weight sensors, etc.), drone drop compartments configured to receive packages via drone drop mechanisms, landing pad compartments, global positioning satellite chip enabled functionality, controlled substance compartments comprising heightened access requirements, emergency compartment configurations to carry emergency supplies for access by the general public in case of emergencies, base station for swiveling of a locker, surveillance camera components, microphone components, and other such components.

In another aspect, smart locker device(s) 108 can comprise a system comprising at least one processor, where the system is configured to execute operations such as access control to smart locker device compartments, identity validation of users or consumers of the smart locker device 186, electronic locking and unlocking mechanisms of the compartment lock, provisioning of user permissions to interact with eh smart lockers, execution of online and offline operational functions, controlling and initiating commands for the smart locker device 108, adjusting various settings, deploying presentations and graphics via a user interface display of the smart locker device 108, scheduling access operations, storing packages within the smart locker device 108, executing geo-fencing operations related to the smart locker device(s) 108, employing measuring functions of the smart locker device 108.

Furthermore, in one or more embodiment, smart locker device 108 can comprise firmware that can be configured to provide corresponding functionality between smart locker platform module 106 and client smart locker module 180. For instance, the firmware can be configurable to facilitate the exchange of information, such as images, package labels, audio, video, addresses, commands, queries, messages, and so forth. Furthermore, the firmware can drive hardware of the smart locker device(s) 108 to generate signals and/or process messages used in maintaining a wireless and/or wired communication session. In another aspect, the firmware can be configurable to facilitate data exchanges between smart locker device(s) 108 with other smart locker device(s) 10 and other devices (e.g., tablets, computers, smart phones, etc.).

In another aspect, environment 100 comprises one or more server device(s) 102 can employ smart locker platform module 106 configured to execute smart locker device(s) 108 operations, manage smart locker systems, and facilitate all interactions between computing device(s) 104 and smart locker device(s) 108. In an aspect, one or more of the various components and/or modules further described herein can be communicatively coupled to a workload layer of a cloud computing environment to distribute processing activities across a cloud environment. In a non-limiting example embodiment smart locker platform module 106 can employ application services module 152, framework module 154, persistence module 156, and gateway and integration module 158.

In an aspect, smart locker platform module 106 can be configured as a platform that comprises various components, modules, and frameworks implemented to support, create, and manage applications corresponding to smart locker device(s) 108. In an aspect, platform module 106 can enable the delivery of functionality that is tailored to an array of devices such as smart locker device(S) 108 and computing device(s) 104 (e.g., servers, computing terminals, laptops, etc.). In one or more non-limiting implementations, the interconnected architecture of server device(s) 102 allows smart locker platform module 106 to scale and/or manage resources to optimally tailor experiences to all client devices (e.g., computing device(s) 104, smart locker device(s) 108) receiving cloud-based services.

In a non-limiting embodiment, a class of target devices can be created such that experiences can be tailored to the generic class of devices. For instance, a device class may comprise physical features, types of usage, or other common characteristics under a particular definition. Furthermore, in one or more implementation, smart locker platform module 106 can scale and/or manage resources to determine the optimal distributions of such resources among respective devices. For instance, several smart locker device(s) 108 may undertake a high volume of transactions at a given point in time (e.g. after work hours between 5 pm-6 pm) at which point, the smart locker platform module 106 may determine a scale-up of server resources are necessary to satisfy such spike in transactions.

As such smart locker platform module 106 can measure performance indicators of system 100, such indicators including storage usage, memory usage, network bandwidth and other parameters to determine the need for adding or removing resources to support vicissitudes in smart locker device(s) transaction support (e.g., data curation, execution of physical smart locker operations, generation of queries, procurement of insights, and other such indicators. In another aspect, smart locker platform module 106 can comprise various components and frameworks to create and manage applications related to smart locker device(s) 108. Furthermore, the smart locker platform module 106 can allow data to synchronize and share data faster across carious smart locker device applications.

In an aspect, platform module 106 can implement data redundancy across platform layers in order to prevent data loss and allow for greater opportunities to recapture data during data recovery events. Furthermore, smart locker platform module 106 can enable automation of connected device(s) such as smart locker device(s) 108 within the smart locker device environment.

In some embodiments, smart locker platform module 106 can enable operability and connectivity of devices such as hardware connectivity, device cloud connectivity, application connectivity, data management, data storage, data provisioning (e.g., amongst stakeholder systems and devices, sensors, applications), management of smart locker device(s) 108 and applications through wired and/or wireless networks, management of sensors and actuators of the smart locker device(s) 108, management and analysis of aggregated data corresponding to connected smart locker assets and networks to produce actionable insights for specific smart locker device challenges and functions, and other such operability.

In some non-limiting embodiments, smart locker platform module 106 can employ different types of stack architectures that employ multiple interconnected layers. For instance, smart locker platform module 106 can employ application layers, networking layers, workload layers, hardware layers, software layers, management layers, virtualization layers, and other such layers. Furthermore, various implementations can integrate aspects of smart locker platform module 106 into any one or more combination of layers utilizes by cloud-based services. In an instance, one or more of the layers and/or modules disclosed herein can be communicatively coupled to a workload layer of a cloud computing environment to distribute operations such as data generation, insight procurement, smart locker device(s) 108 operability, and other such operations. In an aspect, smart locker platform module 106 can employ application services layer 152, framework layer 154, persistence layer 156 and gateway and integration layer 158.

In a non-limiting embodiment, application services layer 152 can represent an organized of programmable components that interact with other layers (e.g., sequentially, hierarchically, etc.). In an aspect, application services layer 152, can be configured to implement functionality associated with one or more smart locker applications. Furthermore, the application service module can employ an interface configured to permit client device access to a series of applications in a uniform manner. In another aspect, application services layer 152 can enable applications to communicate within a common layer with a common application interface while also maintaining compartmentalization of application components. For instance, application services layer 152 can encapsulate access to a shared database and can plug into a source tree related to the application execution. Furthermore, in an aspect, application services layer 152 aggregate application level operations configured for reuse by several clients (e.g., application-level logic is used in several different controllers), such as smart locker device(s) 108, client device(s) 104, complimentary devices (e.g., package reader devices integrated with the smart locker devices) and other such devices. In yet another aspect, application services layer 152 can be used as an aggregator for queries if it is over a repository pattern and over a query object pattern.

In another non-limiting embodiment, smart locker platform module 106 can employ infrastructure framework layer 154. In an aspect, infrastructure framework layer 154 can be configured as an abstracted set of executable code configured to provide tested general functionality to enable deployment of applications and integrations. The infrastructure framework layer 154 can also provide technical capabilities that support application services layer 152 and other such layers disclosed herein. In yet another aspect, infrastructure framework layer 154 can employ capabilities such as message sending for an application, persistence for one or more domain, drawing widgets for a user interface, and other such capabilities. Also, infrastructure framework layer 154 can be configured to support a pattern of interactions between other layers through an architectural framework.

In yet another non-limiting embodiment, smart locker platform module 106 can employ persistence layer 156 configured to mediate operations between a database engine and application services layer 152. Furthermore, persistence layer 156 enables efficient migration of data to other storage engines that encapsulate database logic within a single layer to enable future modification or replacement of database logic. Furthermore, persistence layer 156 can separate data access components of smart locker platform module 106 from the application execution components in case of a need to change databases. As such, persistence layer 156 allows for a data layer modification in some instances instead of the application services layer 152 or infrastructure framework layer 154.

In another aspect, smart locker platform module 106 can employ gateway and integration layer 158. In an aspect, gateway and integration layer 158 can be configured to register a consumer through a REST API by specifying a unique name and attribute filter for the user. Furthermore, in an aspect, within a fragmentally distributed infrastructural environment (e.g., independent infrastructures, manufacturers components of some smart locker devices), gateway and integration layer 158 can enable a sharing of data and collaboration amongst fragmented devices as well as back-end applications corresponding to a range of devices. Furthermore, gateway and integration layer 158 can be configured to act as an interface standardization tool for device-layer or application integration, orchestration layer for smart locker device(s) 108 resources and other back-end services among different organizations for service-layer integration, and/or execute structured and repeatable operations for smart locker device(s) 108.

In another non-limiting embodiment, server(s) 102 can comprise database(s) 160 configured to store information such as data. In an aspect, database(s) 160 can organize large volumes of data and address large amounts of structured and unstructured data. Furthermore, in an aspect, database(s) 160 can provision formats and structures that allow for consistency in stored data that generates efficiencies in how data is accessed and processed. In another aspect, database(s) 160 can represent any suitable source of data and/or information or storage for data generated by smart locker platform module 106. In another aspect, database(s) 160 can respond to queries, store data according to relational data models or data models or data curation requirements. Also, database(s) 160 can be configured to enable curated storage operations via a prioritization scheme of databases and/or data sources for access by the smart locker platform module 106.

In other embodiments, database(s) 160 can be configured to employ data updating prioritization schemes configured to reduce latency of performance associated with smart locker platform module 106 based de-prioritizing updates of less used and/or obscure data. Furthermore, in some instances, database(s) 160 can be programmatically accessed to return a value, sorted data, numeric sequence requested by smart locker platform module 106. In other instances, database(s) 160 can also store data at rest (e.g., store data after collection or generation) as well as store data in motion (e.g., data collected in real-time). Furthermore, database(s) 160 can employ an interface that can communicate with other device(s) and components such as smart locker platform module 106.

In another aspect, database(s) 160 can be configured as any suitable type of database, data warehouse and/or cloud application such as Structured Query Language (SQL) databases, enterprise data warehouses, data marts, software-as-a service (SaaS) based applications, and other such databases. In an aspect, the database(s) 160 can be assigned to workspaces associated with each smart locker device(s) 108, respective computing device(s), and/or applications executing on smart locker platform module 106. Furthermore, database(s) 160 can employ tables and/or data structures to describe relations between data and device(s). As such, database(s) 160 can store relational data models associated with smart locker data curation for particular use (e.g., executing smart locker commands and/or operations).

In an aspect, database(s) 160 can include one or more database interfaces such as SQL interfaces. Furthermore, database(s) 160 can be configured to receive database access commands, consolidate data access events. In another aspect, database(s) 160 can comprise learning databases (e.g., anecdotal data associated with thematic databases such as those databases associated with images, text, package label images, formatting data, addresses, and other such learning databases). In another aspect, database(s) 160 can curate images associated with key words such as “package”, “label”, “shipping”, “address”, and other such images.

In an aspect, smart locker platform module 106 can be configured to communicate with autonomous chassis and/or smart locker integrated with (or stand alone) autonomous chassis vehicle. For instance, smart locker platform module 106 can execute operations such as monitoring autonomous chassis vehicle locations or global positioning coordinates. Furthermore, smart locker platform module 106 can execute notification commands, authentication operations, automated opening/closing of smart locker compartment doors, and/or other commands.

In another aspect, server(s) 102 can employ first communication module 170 configured as a component of a server that communicates with external devices. Furthermore, first communication module 170 is configured to represent any suitable combination of hardware, software, and/or firmware configurable to facilitate the exchange of information (e.g., images, audio, video, commands, queries, messages, etc.). In another aspect, first communication module 170 can include protocol stacks associated with a network over which data can be exchanged, firmware that can cause the hardware to generate signals and/or process messages used to maintain a wireless communication session.

In an aspect, some implementations include computer networking ports such as Transmission Control Protocol (TCP) port, User Datagram Protocol (UDP) port, File Transfer Protocol (FTP) port, Hypertext Transfer Protocol (HTTP) port, Internet Message Access Protocol (IMAP) port, and Physical communication ports. In yet another aspect, first communication module 170 can be configured to include physical communication ports, serial ports, parallel ports, keyboard ports, universal serial bus (USB) ports, a keyboard port, a display port, an audio port, and other such ports. Furthermore, in an aspect, first communication module 170 can be configured to connect server(s) 102 to other devices over communication cloud 128, such as computing device(s) 104.

In another aspect, system 100A can include computing device 104 which can include client smart locker module 180 that generally represent user access some or all of the functionality provided by client smart locker module 180. In an aspect, computing device(s) 104 can be any suitable type of computing device such as a desktop computing device, a smart phone, a tablet, a laptop, a smart watch and so forth. Furthermore, client smart locker module 180 can provision output information generated from a combination of input data and user information based on smart locker device(s) preferences and other such information.

In some implementations, client smart locker module 180 can represent user access to some or all of the functionality provided by smart locker platform module 106. In another aspect, client smart locker module 180 can represent a stand-alone client application (e.g., smartphone, desktop computer application, etc.) that interfaces into smart locker platform module 106. Furthermore, client smart locker module 180 can represent a browser that remotely logs onto a website hosted by server(s) 102. For instance, client smart locker module 180 and smart locker platform module 106 are illustrated as residing on separate devices, however, some implementations combine some or all the respective module functionality into a single computing device as further described herein. Further, in various implementations, computing device(s) 104 can use client smart locker module 180 to access smart locker device(s) 108 as further described herein. In other implementations, computing device(s) 104 can use client smart locker module 180 to access cloud-based services provided by server(s) 102 via a browser that can remotely log onto a site hosted by server(s) 102. In such example, client smart locker module 180 can include a user interface such as display module 190 to provide user access into features provided by the system, such as inputting a search query, provided user feedback, requesting reports, accessing a dashboard, scheduling smart locker device operations, opening a smart locker compartment, unlocking a smart locker locking mechanism, querying smart locker device data, and other such features.

In a non-limiting embodiment, client smart locker module 180 can employ client services module 110 configured to correspond to a client application that can render a user interface on a corresponding display device (e.g., tablet, computer, etc.), and communicates over a network to a server application such as smart locker platform module 106. In another aspect, client services module 110 can represent a stand-alone application that includes the functionality of service applications executing on smart locker platform module 106 and/or smart locker device(s) 108. For instance, such service applications can include a mailroom service, locker service, service room, inventory service, package room service, recipient services, service level management service, user detection and identification services and other such applications.

In another non-limiting embodiment, client smart locker module 180 can employ client partner module 120 configured to employ a client application that can render a user interface on a corresponding display device (e.g., tablet, computer, smart locker device, etc.), and communicate over a network to a server application such as smart locker platform module 106. Furthermore, client partner module 120 can represent a stand-alone application that can include the functionality of partner applications executing on smart locker platform module 106 and/or smart locker device(s) 108. For instance, such partner applications can include horizontal partners such as network configuration partners, security partners, data visualization partner systems, and/or smart locker device orchestration applications.

In another non-limiting embodiment, client smart locker module 180 can employ client integration module 130. In an aspect, client integration module 130 corresponds to a client application that renders a user interface on a corresponding display device (e.g., tablet, computer, etc.) and communicate over a network to a server application such as smart locker platform module 106. In another aspect, client integration module 130 can represent a stand-alone application that includes the functionality of integrations applications executing on smart locker platform module 106. For instance, such integrations can include a single-sign on application for various identity providers and service providers related to smart locker device(s).

Other integrations can include an API based integrations configured to transmit information and extract information and vice versa to respective API's of smart locker platform module 106. Other integrations can include event-driven integrations configured to receive events such as notification events corresponding to status changes or other events corresponding to the smart locker platform module 106 or smart locker device(s) (e.g., locker door is left open, locker has package in it, locker door is jammed). In other implementations, integrations can include package tracking, package management applications, customer application integrations (e.g., retailers, universities, apartments, wholesalers, etc.), user data import applications or systems. Furthermore, client integration module 130 can provide device access to various features corresponding to integrations provided by the smart locker platform module 106 or smart locker device(s).

In another non-limiting embodiment, client smart locker module 180 can employ client analytics module 150. In an aspect, client analytics module 150 can correspond to a client application that renders a user interface on a corresponding display device (e.g., tablet, computer, etc.), and communicate over a network to a server application such as smart locker platform module 106. Furthermore, client analytics module 150 can represent a stand-alone application that includes the functionality of analytics applications executing on smart locker platform module 106. In another aspect, client analytics module 150 can receive analytics related to the smart locker device(s) over network 114. Furthermore, various triggering events (e.g., package deposited, package retrieved, label tracking info. extracted, transaction occurred) can provision insights and information to the client analytics module 150. In yet another aspect, client analytics module can accesses various features corresponding to analytics generation, management and provisioning provided by the smart locker platform module 106. In another aspect, client device(s) 104 can employ second communication module 196 configured as a combination of hardware, software, and/or firmware that is configurable to facilitate data exchanges with other devices.

FIG. 1B illustrates a diagram of a non-limiting, example autonomous delivery vehicle configured to integrate with smart locker devices and employ package delivery operations in accordance with one or more embodiments described herein. Repetitive description of like elements employed in other embodiments described herein is omitted for sake of brevity.

In an aspect, disclosed is autonomous delivery vehicle 100B configured with rear wheel chassis portion 110, rear wheels 120A, front wheels 120B, first guide rail 130A, second guide rail 130B, and tractor portion 140. In a non-limiting embodiment, the chassis portion 150 can be configured to receive, integrate with, and/or interlock with a smart locker device(s) 108 or other such smart locker devices. As such, chassis portion 150 can be configured as a receiving platform for smart locker integrations. In other aspects, chassis portion 150 can be configured with a power source, a motor, power ports and wheels. In an aspect, the motor can be powered by the power source via connected power ports. In another aspect, chassis portion 150 can be connected to a steering mechanism controllable via an autonomous control system. In another aspect, the steering mechanism can be connected to the power source via power cables In an aspect, the smart locker device(s) 108 can be a bank of smart lockers comprising locker compartments configured to receive, store, and deploy packages to users. For instance, the smart locker compartments can be loaded with packages intended for respective recipients. The smart locker compartments can be locked and configured to open based on satisfaction of access requirements from an authenticated user such as the package recipient or an authorized delivery personnel. Furthermore, the smart locker compartments can be configured to trigger an unlocking of a respective compartment based on geo-fencing mechanisms.

For instance, upon an autonomous vehicle reaching a target destination (as per verification from a location tracker, such as GPS tracking coordinates of the vehicle), then a compartment door can be triggered to unlock and allow access to a package. Accordingly, upon the autonomous delivery vehicle 100B reaching a respective users home address, the respective compartment storing a package for such user can be automatically unlocked to allow for delivery of the package. In another aspect, a compartment configured as a drone drop box can allow a drone to carry the package from the smart locker device to a secure location at the user home (e.g., porch, mailbox, residential smart locker device and system, etc.). In yet another embodiment, the compartment storing a package can open based on two factor authentication such as a matching (e.g., by smart locker platform module) of the location coordinates of autonomous delivery vehicle 100B (e.g., smart chassis with smart locker)

In another aspect, the chassis portion 150 can be configured as a platform capable of receiving a variety of smart locker configurations. The chassis can comprise elements such as a powertrain, engine, transmission, and other framework elements that allow that chassis to move from location A to location B. Furthermore, the chassis can be configured with sensors and system implementations that allow for the chassis portion 150 to move in an autonomous manner based on automated control command issuance, movement planning, scheduling determinations, and sensor information collection and analysis.

In another aspect, chassis portion 150 can move forward and backwards and can employ steering controls elements, braking control elements, power source mechanisms, and other car mechanisms. Furthermore, chassis portion 150 can comprise rear wheels 120A and front wheels 120B configured as support members for the chassis portion 150 and configured to enable the vehicle to move. In another aspect, first guide rail 130A and second guide rail 130B are configured as protruding rails capable of receiving smart locker devices such as smart locker banks to integrate with such rails. For instance, a smart locker device can slide across first guide rail 130A and second guide rail 130B and integrate (e.g., via locking mechanism) with the chassis based on the guide rails providing support for the smart locker device.

In another non-limiting embodiment, the first guide rail 130A and the second guide rail 130B serve as integrative protrusions configured to receive one or more bank of smart locker devices. Furthermore, first guide rail 130A and second guide rail 130B allow for an easy receipt of the smart locker bank onto the chassis portion 150 of the vehicle. In a non-limiting embodiment first guide rail 130A and second guide rail 130B can slide horizontally beneath a raised bank of smart locker devices that can be lowered or slid onto the guide rails. In another aspect, the first guide rail 130A and second guide rail 130B can horizontally slide within slats of a pallet, on which the smart locker banks are resting. As the guide rails extend back into its default position, the pallet with the bank of smart lockers can slide towards the rails as well until the smart locker banks are firmly positioned atop of the chassis portion 150 and integrated with a locking mechanism.

In another non-limiting embodiment, first guide rail 130A and second guide rail 130B can be configured as beams capable of moving horizontally and up and down to facilitate loading of the smart locker banks or smart locker banks stationed on palettes. In another non-limiting embodiment, a crane can be employed at a loading facility or connected to the autonomous package delivery vehicle that is configured to pick up the smart locker banks, lift into the air and move onto the chassis portion 150 of the autonomous package delivery vehicle. In other non-limiting embodiments, the smart locker banks can be manually (e.g., pushing) or autonomously push loaded onto the chassis portion 150.

In another aspect, disclosed is tractor portion 140 of the autonomous package delivery vehicle. The tractor portion 140 can include a motive unit of the autonomous package delivery vehicle that can include an engine with sufficient power and durability to successfully pull the smart locker banks. In some non-limiting embodiments, the tractor portion 140 can be detached from the chassis portion 150. As such, the detachment capability of the tractor portion 140 from the chassis portion 150 can allow for quick unloading of a chassis holding an empty smart locker unit, and the tractor portion 150 can inter-connect with another chassis pre-loaded with another set of smart locker units storing packages for delivery. In another non-limiting embodiment, rear wheel chassis portion 140 includes a portion of the chassis body configured to fit over rear wheels 120A.

In an aspect, the autonomous package delivery vehicle 100B can perform driving and delivery activities based on a predefined or on-demand delivery route mechanism. For instance, the autonomous package delivery vehicle can be configured to drive a delivery route that stopped at each location associated with a package within the storage compartments of the smart locker bank loaded onto the autonomous delivery vehicle chassis. As such, each autonomous vehicle can follow a customized delivery route based on the smart locker bank and packages stored with the smart locker banks. Furthermore, the autonomous delivery vehicle 100B can execute operations in accordance with a pre-defined delivery route system configured to determine and optimize delivery routes associated with packages for delivery stored in smart locker banks. In an aspect, each destination location can correspond to definite coordinates capable of being identified by a global positioning satellite (GPS). Furthermore, a delivery system can determine a string of coordinates in a particular order for the autonomous delivery vehicle to visit in order to deliver packages stored within the smart locker bank compartments mounted onto the chassis portion 150.

In another aspect, the smart locker banks configured to integrate with autonomous package delivery vehicles can employ ultraviolet mechanisms capable of emitting ultraviolet light within smart locker compartments of the smart locker banks in order to sanitize surfaces of packages stored within smart locker compartments. In an aspect, the ultraviolet light emissions can sanitize packages potentially carrying COVID-19 and/or SARS contagions. In a non-limiting embodiment, the autonomous package delivery vehicle can be configured with interchangeable components such that the components can be utilized with other autonomous vehicles. As such, autonomous vehicles can be modified to receive smart locker banks based on integration of components of the autonomous package delivery vehicle. For instance, chassis component 150 can be mounted onto existing components of another autonomous vehicle design to allow for smart locker bank integration capabilities of another autonomous vehicle design.

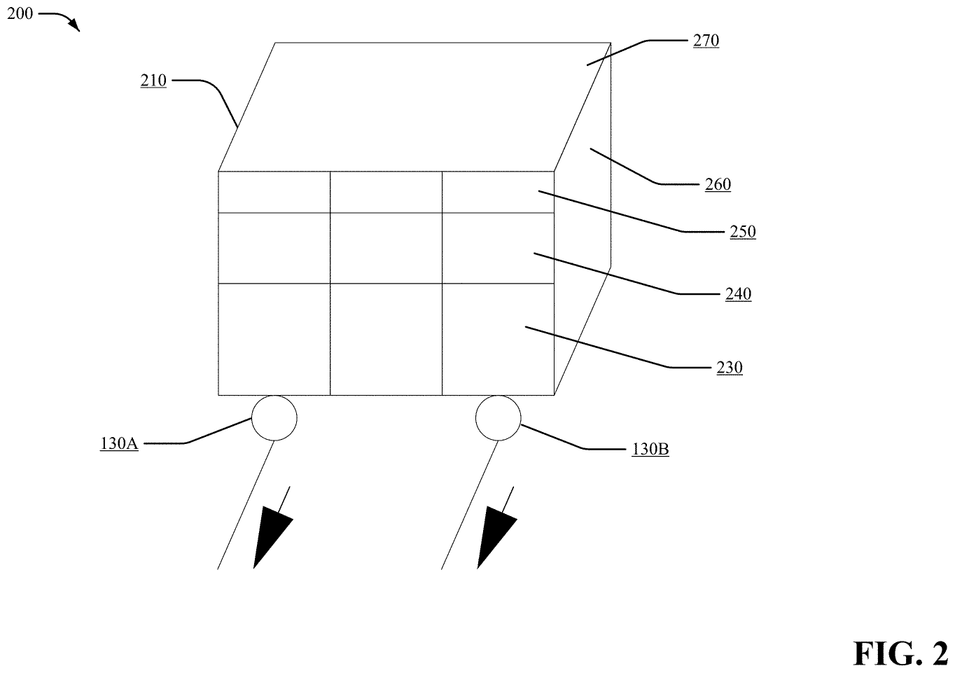

Turning now to FIG. 2, illustrated is a diagram of a non-limiting example smart locker device 200 configured to integrate with the autonomous delivery vehicle in accordance with one or more embodiments described herein. Repetitive description of like elements employed in other embodiments described herein is omitted for sake of brevity.

In an aspect, smart locker bank 210 comprises a bank of smart lockers with an assortment of compartments. The smart locker compartments can be of varying size or of uniform sizing. For instance, first locker compartment 250 is smaller than second locker compartment 240, and second locker compartment 240 is smaller than third locker component 230. As such, different sized packages can be stored in different size compartments accordingly. In another aspect, the smart locker bank 210 can be configured with a top portion 270 and side wall portion 260. In non-limiting embodiments, there can be compartments with access doors located on more than one side of the smart locker bank 210. In another aspect, first guide rail 130A and second guide rail 130B are illustrated such that they are moved under the smart locker bank 210 and capable of retracting back onto the chassis portion of the autonomous package delivery vehicle to move the smart locker bank 200 onto the chassis.

Turning now to FIG. 3A, illustrated is a diagram of a non-limiting, example autonomous delivery vehicle 300A integrated with a smart locker device configured for such integration in accordance with one or more embodiments described herein. Repetitive description of like elements employed in other embodiments described herein is omitted for sake of brevity. In an aspect, illustrated is an autonomous delivery vehicle 300A that has been successfully loaded with a smart locker bank (e.g., smart locker device(s) 108). The autonomous delivery vehicle 300A can autonomously drive in accordance with determined (e.g., using smart locker platform module 106) scheduled routes to coordinate the delivery routes required to deliver the packages stored within the locker compartments. In an instance, the scheduled rights can correspond to delivery addresses or customer coordinates corresponding to the packages or items stored within the smart locker bank compartments.

In an aspect, the autonomous delivery vehicle 300A can travel several routes and replenish a new smart locker bank at a package and locker fulfilment center to provision deliveries to new routes throughout the day. Unlike current courier modalities, the autonomous delivery vehicle 300A does not need to take mandatory breaks for rest and can employ energy efficient driving techniques to optimize delivery times and maximize the number of packages provided to customers per day. Furthermore, determined driving routes can be adjusted in real-time and such adjustments can be implemented across more than one autonomous vehicle to create efficiencies based on real time changes throughout the day. For instance, a customer that cancels a delivery or changes an address for drop off in real-time can be accommodated based on smart locker platform module redetermining an optimal delivery route based on the variable change.

Turning now to FIG. 3B, illustrated is a diagram of a non-limiting, example autonomous delivery vehicle 300B integrated with a smart locker device configured for such integration in accordance with one or more embodiments described herein. Repetitive description of like elements employed in other embodiments described herein is omitted for sake of brevity. At reference numeral 140 is another non-limiting embodiment of one or more processors, modules, firmware, and hardware employed to enable another non-limiting embodiment of an autonomous delivery vehicle 300B to drive autonomously. For instance, the autonomous software can enable the engine and power source to propel the vehicle forward and steer the vehicle in accordance with instructions provisioned from smart locker platform module 106. In an aspect, chassis portion 150 represents a chassis portion of the smart locker platform module 106 configured to receive a smart locker bank for docking. Also illustrated are front wheels 120B and rear wheels 120A.

Turning now to FIG. 3C, illustrated is a diagram of a non-limiting, example autonomous delivery vehicle 300C integrated with a smart locker device configured for such integration in accordance with one or more embodiments described herein. Repetitive description of like elements employed in other embodiments described herein is omitted for sake of brevity. At reference numeral 140 is another non-limiting embodiment of one or more processors, modules, firmware, and hardware employed to enable another non-limiting embodiment of an autonomous delivery vehicle 300C to drive autonomously. For instance, the autonomous software can enable the engine and power source to propel the vehicle forward and steer the vehicle in accordance with instructions provisioned from smart locker platform module 106. In an aspect, reference numeral 150 represents a chassis portion of the smart locker platform module 106 configured to receive a smart locker bank for docking. Also illustrated are front wheels 120B and rear wheels 120A. Also disclosed is smart locker bank 210 configured to dock and undock to and from chassis portion 150.

Turning now to FIG. 3D, illustrated is a diagram of a non-limiting, example autonomous delivery vehicle 300D integrated with a smart locker device configured for such integration in accordance with one or more embodiments described herein. Repetitive description of like elements employed in other embodiments described herein is omitted for sake of brevity. At reference numeral 140 is another non-limiting embodiment of one or more processors, modules, firmware, and hardware employed to enable another non-limiting embodiment of an autonomous delivery vehicle 300D to drive autonomously. For instance, the autonomous software can enable the engine and power source to propel the vehicle forward and steer the vehicle in accordance with instructions provisioned from smart locker platform module 106. In an aspect, reference numeral 150 represents a chassis portion of the smart locker platform module 106 configured to receive a smart locker bank for docking. Also illustrated are front wheels 120B and rear wheels 120A. In a non-limiting embodiment, the smart locker bank is monolithically affixed to chassis portion 150 and does not undock or dock unlike other embodiments disclosed herein.

Turning now to FIG. 4A, illustrated is a diagram of a non-limiting, example autonomous delivery vehicle fulfillment system 400A configured to enable efficient package and smart locker device fulfillment operations in connection with the autonomous delivery vehicle in accordance with one or more embodiments described herein. Repetitive description of like elements employed in other embodiments described herein is omitted for sake of brevity.

In an aspect, fulfillment system 400A illustrates an first autonomous delivery vehicle 100B-1 (e.g., chassis portion 150) loaded with integrated first smart locker bank 210A. In an aspect, autonomous delivery vehicle 100B-1 can arrive at a fulfillment center to drop off first smart locker bank 210A that completed a delivery route and available to unload empty first smart locker bank 210A. As such, first smart locker bank 210A can transferred and loaded onto the chassis portion 150 of autonomous delivery vehicle 100B-1 (or autonomous delivery vehicle 100B disclosed herein) via the guide rails or other such loading mechanism to an empty storage section 420 of the fulfillment center. In an aspect, the first smart locker bank 210 can be loaded or unloaded onto/from the chassis portion of autonomous delivery vehicle 100B-1 via a roll mechanism (e.g., smart lockers roll onto chassis), jacking or forklifting mechanisms (e.g., raising the locker banks onto chassis), overhead mechanism (e.g., ramp, crane, etc.), smart locker push mechanism and locking mechanism (e.g., pushing the smart locker onto the chassis and locking the smart lockers in place) or other such mechanism. In an aspect, the smart locker banks can integrate with a chassis portion 150 of autonomous delivery vehicle 100B-1 via any of a range of locking mechanisms such as retractable twist locks, non-retractable smart locker twist locks, retractable and non-retractable locking pins, aperture attachments, and other such locking mechanisms.

In another aspect, autonomous delivery vehicle 100B-1 can travel forward or to another loading location to be re-loaded (e.g., docked with a second smart locker bank 210B) with second smart locker bank 100B-2. In an aspect, autonomous delivery vehicle 100B-2 is shown docking second smart locker bank 210B from the fulfillment center, where second smart locker bank 210B can be pre-loaded with packages stored in the locker compartments. In an aspect, the packages can be associated with order identifiers and customer delivery destinations that meet a pre-determined or custom delivery route by which autonomous delivery vehicle 100B-2 will travel. In another aspect, second smart locker bank 100B-2 can be transferred via the guide rails from a storage fulfillment section 430 of fulfillment center 400.

Accordingly, an efficient transfer of locker banks can be executed given the structure of the autonomous vehicle and the mechanisms by which lockers can be loaded and unloaded onto the chassis, along with several other factors. In an aspect, upon deployment of autonomous delivery vehicle 100B-1 or autonomous delivery vehicle 100B-2 based on a pre-determined delivery route corresponding to the first smart locker bank 100B-1 or first smart locker bank 100B-2 respectively, smart locker platform module 106 can employ modules to execute operations such as open or close smart locker compartment doors, lock or unlock smart locker compartment doors, generate QR codes as access mechanisms to smart locker compartments, provision data (e.g., queried data, curated data, data related to smart lockers, data related to autonomous delivery vehicles, etc.) via application programming interfaces, execute application operations (e.g., order generation, order fulfillment, delivery route generation, automated driving, vehicle monitoring, location determination, etc.), commanding third party autonomous vehicles, integrating with other platform or other application modules, and other such operations.

In a non-limiting example embodiment, fulfillment system 400A illustrated in FIG. 4A can include the following components. In an aspect, a customer can execute a client application employed by a client device (e.g., smartphone) to order an item (e.g., product) to be delivered to a customer destination via a package delivery mechanism (e.g., package delivery via autonomous delivery vehicle). The order can be received, via another application executing on a server device (e.g., a fulfillment center server or database). In another aspect, an application executing on the server device (e.g., fulfillment center server) such as a fulfillment center application can generate an order identifier associated with the customer order request. Furthermore, the fulfillment center application can assign the order identifier to the package and map the order identifier to a set of customer information (e.g., customer name, delivery address, unique global positioning coordinates associated with a delivery address, phone number, email alias for instance of a customer picking up the order).

In another aspect, one or more automated packaging device or packaging systems (e.g., automated fulfillment equipment, automated bagging machines, autonomous bagging systems, automated sorting systems, cold seal auto packers, automated wrapping equipment, void fill equipment, etc.) or personnel can collect, procure, and/or fulfill package orders for a target order identifier (e.g., order ID: 1234). The automated equipment or personnel can sort orders (e.g., order 1, order 2, order 3, etc.) and determine package fulfillment and smart locker bank storage assignments for respective packages based on predetermined routes corresponding to the smart locker bank. Furthermore, the automated equipment (e.g., robotic arm) or personnel can scan package labels and deposit packages into smart lockers (e.g., smart locker pod's or smart locker banks) configured for loading and integration onto an automated chassis vehicle. In an aspect, an autonomous chassis vehicle (e.g., automated delivery 100B, etc.) can arrive at a loading dock and await a loading of the smart locker bank onto the chassis vehicle.

In an aspect, the pre-loaded smart locker can be loaded onto a chassis portion 150 of autonomous delivery vehicle 100B-2. In an aspect, the loading can occur based on a pushing, via guard rails, a rolling of the smart locker bank, or a mechanical dropping of the smart locker bank onto the chassis portion 150. Furthermore, the smart locker bank can interlock with the chassis based on any of a manual locking, automatic locking, self-locking, or other such locking mechanism that ensures a physically secure loading of the banks on the chassis. Accordingly, upon occurrence of an interlocking event between smart locker bank and chassis portion 150, the information is synched between the autonomous vehicle and the smart locker bank. In another non-limiting aspect, smart locker platform module 106 can generate QR codes for each order stored in a smart locker compartment. Furthermore, the QR codes are mapped to corresponding order identifier information and customer information (e.g., address, package contents, etc.).

Furthermore, in an aspect, autonomous delivery vehicle 100B-2 (e.g., chassis with smart locker) can execute instructions (e.g., received from a routing application) based on the pre-loaded smart locker bank 210 locked into chassis portion 150. As such, once the smart locker bank is locked to the chassis, smart locker platform module 106 can employ delivery routes based on delivery criteria (e.g., zip codes, delivery route locations, etc.) corresponding to the packages stored in the smart locker bank 210. Furthermore, in an aspect, the smart locker bank 210 can communicatively couple with the autonomous delivery vehicle 100B-2 and/or smart locker platform module 106. Accordingly, smart locker platform module 106 provisions route instructions to autonomous delivery vehicle 100B-2 comprising of a series of global positioning satellite coordinates associated with the zip codes and order identifiers corresponding to stored packages with the smart locker bank compartments.

In an aspect, autonomous delivery vehicle 100B-2 can be summoned along the route of zip codes and GPS coordinates associated with the packages requiring delivery. Upon the arrival of autonomous delivery vehicle 100B-2 at a target destination (as indicated by the vehicle positioned at a set of target GPS coordinates, smart locker platform module 106 can match the vehicle GPS coordinates to the target destination GPS coordinates. Furthermore, smart locker platform module 106 can monitor the location of the autonomous delivery vehicle 100B-2 and trigger (e.g., using geo-fencing mechanisms) a notification to a client device (e.g., application executing on a smartphone, phone number, email, etc.) that indicates the estimated time of arrival of autonomous delivery vehicle 100B-2. In another aspect, upon the smart locker platform module 106 achieving a match between the autonomous GPS coordinates with the target destination coordinates, then another notification to the client device is triggered or an automated ringing of a smart doorbell occurs (if relevant).

A client device (e.g., smartphone) can activate the access code to retrieve the package. Furthermore, the QR access code/GPS coordinates can be mapped to the address and the order identifier. Accordingly, smart locker platform module 106 can employ a multi-factor authentication mechanism to validate the recipient and the smart locker doors. Upon validation of the multi-factor-authentication mechanism, the compartment door can automatically open (e.g., triggered via a command from smart locker platform module 106 upon satisfaction of multi-factor authentication requirements). In a non-limiting embodiment, a smartphone device can be automatically authenticated via a Bluetooth protocol in some instances. In yet another aspect, all the smart locker compartment doors associated with the authenticated user can automatically open for retrieval of stored contents (e.g., packages, controlled substances, food delivery, cargo, laundry, groceries, etc.).

In an aspect, upon the closing of the compartment door, smart locker bank provisions a notification to smart locker platform module 106, which in turn, notifies autonomous delivery vehicle 100B-2 to resume travel to the next destination along the automated delivery route. Also, in an aspect, various configurations of smart lockers (e.g., single stand-along locker compartment, small locker bank, medium locker bank, large locker bank, etc.) can be employed to integrate with a wide array of autonomous delivery vehicles including third party passenger autonomous vehicles.

For instance, a stand-alone small smart locker device with a few compartments can be configured to embed in the trunk of an autonomous passenger vehicle. Furthermore, such autonomous passenger vehicle can communicatively couple with smart locker platform module 106. As a result, any autonomous vehicle can be operationalized to perform automated route delivery operations. In an aspect, any user can employ its autonomous vehicle to deliver packages via smart locker integration and pre-determined route delivery based on scheduled time availabilities (e.g., idle time, unused time for the vehicle).

Turning now to FIG. 4B, illustrated is a diagram of a non-limiting, example autonomous delivery vehicle enabled package delivery system 400B configured to enable efficient package delivery in accordance with one or more embodiments described herein. Repetitive description of like elements employed in other embodiments described herein is omitted for sake of brevity.

In an aspect, disclosed herein is an autonomous delivery vehicle comprising a chassis portion 414B interlocked with a docked smart locker bank 412B (represented as a full locker bank). In an aspect, smart locker bank 412B is full of stored packages corresponding to several customers smart devices and customer information (e.g., addresses, etc.). In another aspect, chassis portion 414B undocks the smart locker bank 412B at a target location in the 95135 zip code. As such, first user 411B associated with a 95135 zip code open one or more compartment of smart locker bank 412B-1 storing its respective item (e.g., medicine, packages, groceries, clothes, food, etc.) or stores a new item from delivery elsewhere. Accordingly, autonomous chassis vehicle can route to the fulfillment center and dock a new smart locker bank to take to another destination.

As such, second smart locker bank 420B can be deployed in zip code 95138 where other users such as user 413B can retrieve or deposit items into storage containers of smart locker bank 420B. Furthermore, smart chassis 414B can deposit smart locker bank 420B at zip code 95138. In another aspect, third smart locker bank 430B can be deployed in zip code 94086 where other users such as user 415B can retrieve or deposit items into storage containers of smart locker bank 420B. Furthermore, smart chassis 414B can deposit smart locker bank 430B at zip code 94086. In an aspect, such hub and spoke model can allow more package fulfillment and delivery to occur daily. Accordingly, by depositing smart locker banks in various locations for pre-set periods of time to deliver items from storage and obtain items for storage and/or delivery, the autonomous vehicle chassis can efficiently optimize package pickup, drop off and/or transportation activities in an improved manner. This solves problems associated with traditional package delivery processes and can overcome challenges associated with inefficient route deliveries. In an aspect, the smart chassis 414B can retrieve and drop off smart locker banks according to defined routes and based on optimal storage transactional activity (e.g., number of deliveries or pickups within a respective smart locker bank).

Turning now to FIG. 5A, illustrated is a block diagram of a non-limiting, example system 500A for enable efficient package and smart locker device fulfillment operations in connection with the autonomous delivery vehicle in accordance with one or more embodiments described herein. Repetitive description of like elements employed in other embodiments described herein is omitted for sake of brevity.

In an aspect, disclosed is a system 500A which is configured to execute operations of the automated package delivery vehicle based on a communicatively coupled interaction between a vehicle platform module 590 employed by the automated vehicle device 504 and a DESLA Platform module 530 employed by server(s) 502. In an aspect, DESLA platform module 530 can employ system integrations module 110 to access data from various sources such as sensors, API's, and data generated by the automated vehicle device(s) 504. In another aspect, analytics module 520 can curate data, generate relationships between data sets, and generate insights from analysis of the data. For instance, analysis module 520 can determine insights related to package delivery efficiencies, package storage efficiencies, route optimizations for the automated package delivery vehicle, time requirements to swap locker banks at fulfillment centers, and other such insights.

Turning now to FIG. 5B, illustrated is a block diagram of a non-limiting, example system 500B for dispatching one or more autonomous delivery vehicle in accordance with one or more embodiments described herein. Repetitive description of like elements employed in other embodiments described herein is omitted for sake of brevity.

In an aspect, smart locker platform module 106 can employ an autonomous dispatch system dashboard 510B configured to enable the dispatch of autonomous delivery vehicles. In an aspect, dashboard 510 can provision data and information via one or more first application programming interface 550B and/or second application programming interface 560B. In an aspect 550B can provision instructions, commands, and/or data to one or more module communicatively coupled to a processor 520B of an autonomous chassis or vehicle that can be any autonomous vehicle. For instance, processor 520B can be integrated to a passenger autonomous delivery vehicle that implements a delivery schedule during idle times in its daily schedule. As such, dashboard 510B can be integrated any of a range of autonomous vehicles including, but not limited to passenger vehicles and/or autonomous drone devices. In another aspect, API 560B can be configured to integrate with private smart locker banks 530B (e.g., processor of smart locker banks) customized for integration and docking onto an autonomous vehicle chassis. In another aspect, dashboard 510B can be employed to communicate with autonomous chassis hardware 540B communicatively coupled to processor 520B or integrated within an embodiment of an autonomous delivery vehicle chassis disclosed throughout the disclosure.

Turning now to FIG. 6A, illustrated is a block diagram 600A of a non-limiting method of loading smart locker banks onto an autonomous delivery vehicle in accordance with one or more embodiments described herein. Repetitive description of like elements employed in other embodiments described herein is omitted for sake of brevity.

At reference numeral 610A, one or more smart locker bank (e.g., smart locker bank 210) is loaded onto one or more guide rails of an autonomous delivery vehicle (e.g., autonomous delivery vehicle 100B). At reference numeral 620A, the guide rails retract back onto the autonomous package delivery vehicle. At reference numeral 630A, the smart locker bank integrates onto the chassis of the autonomous package delivery vehicle. At reference numeral 640A, the autonomous package delivery vehicle deploys packages along a predefined delivery route.

Turning now to FIG. 6B, illustrated is a block diagram 600B of a non-limiting method of deploying packages by an autonomous delivery vehicle in accordance with one or more embodiments described herein. Repetitive description of like elements employed in other embodiments described herein is omitted for sake of brevity.

At reference numeral 610B, a server device communicatively coupled to a smart locker bank synchronizes the smart locker bank with an autonomous vehicle chassis based on an interlocking interaction between the smart locker device and the autonomous vehicle chassis. At reference numeral 620B, the server device generates an access code corresponding to an order identifier and customer zip code associated with each locker compartment. At reference numeral 630B, the server device instructs the autonomous vehicle chassis to autonomously drive along a pre-defined route corresponding to customer addresses associated with each locker compartment. At reference numeral 640B, the server device monitors a location of the autonomous vehicle chassis. At reference numeral 650B, the server device matches a current location of the autonomous vehicle chassis to coordinates of a customer destination. At reference numeral 660B, the server device notifies a client smart device of current location of the autonomous vehicle chassis to coordinates of the customer destination. At reference numeral 670B, the server device automatically unlocks one or more smart locker compartment based on authentication of the client smart device via access code verification and based on the matching the current coordinates to the customer destination.

FIG. 7 illustrates a flow diagram of an example, non-limiting operating environment in which one or more embodiments described herein can be facilitates. Repetitive description of like elements employed in other embodiments described herein is omitted for sake of brevity.

In order to provide a context for the various aspects of the disclosed subject matter, FIG. 7 as well as the following discussion is intended to provide a general description of a suitable environment in which the various aspects of the disclosed subject matter can be implemented. FIG. 7 illustrates a block diagram of an example, non-limiting operating environment in which one or more embodiments described herein can be facilitated. With reference to FIG. 7, a suitable operating environment 700 for implementing various aspects of this disclosure can also include a computer 712. The computer 712 can also include a processing unit 714, a system memory 716, and a system bus 718. The system bus 718 couples system components including, but not limited to, the system memory 716 to the processing unit 714.

The processing unit 714 can be any of various available processors. Dual microprocessors and other multiprocessor architectures also can be employed as the processing unit 714. The system bus 718 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 716 can also include volatile memory 720 and nonvolatile memory 722. The basic input/output system (BIOS), containing the basic routines to transfer information between elements within the computer 712, such as during start-up, is stored in nonvolatile memory 722. By way of illustration, and not limitation, nonvolatile memory 722 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 720 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 712 can also include removable/non-removable, volatile/non-volatile computer storage media. FIG. 7 illustrates, for example, a disk storage 724. Disk storage 724 can also include, but is not limited to, devices like a magnetic disk drive, floppy disk drive, tape drive, Jaz drive, Zip drive, LS-100 drive, flash memory card, or memory stick. The disk storage 724 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 724 to the system bus 718, a removable or non-removable interface is typically used, such as interface 726. FIG. 7 also depicts software that acts as an intermediary between users and the basic computer resources described in the suitable operating environment 700. Such software can also include, for example, an operating system 728. Operating system 728, which can be stored on disk storage 724, acts to control and allocate resources of the computer 712.

System applications 730 take advantage of the management of resources by operating system 728 through program modules 732 and program data 734, e.g., stored either in system memory 716 or on disk storage 724. It is to be appreciated that this disclosure can be implemented with various operating systems or combinations of operating systems. A user enters commands or information into the computer 712 through input device(s) 736. Input devices 736 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 714 through the system bus 718 via interface port(s) 738.

Interface port(s) 738 include, for example, a serial port, a parallel port, a game port, and a universal serial bus (USB). Output device(s) 740 use some of the same type of ports as input device(s) 736. Thus, for example, a USB port can be used to provide input to computer 712, and to output information from computer 712 to an output device 740. Output adapter 742 is provided to illustrate that there are some output device 740 like monitors, speakers, and printers, among other such output device 740, which require special adapters. The output adapters 742 include, by way of illustration and not limitation, video and sound cards that provide a means of connection between the output device 740 and the system bus 718. It should be noted that other devices and/or systems of devices provide both input and output capabilities such as remote computer(s) 744.

Computer 712 can operate in a networked environment using logical connections to one or more remote computers, such as remote computer(s) 744. The remote computer(s) 744 can be a computer, a server, a router, a network PC, a workstation, a microprocessor based appliance, a peer device or other common network node and the like, and typically can also include many or all of the elements described relative to computer 712. For purposes of brevity, only a memory storage device 746 is illustrated with remote computer(s) 744. Remote computer(s) 744 is logically connected to computer 712 through a network interface 748 and then physically connected via communication connection 750. Network interface 748 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 750 refers to the hardware/software employed to connect the network interface 748 to the system bus 718. While communication connection 750 is shown for illustrative clarity inside computer 712, it can also be external to computer 712. The hardware/software for connection to the network interface 748 can also include, for exemplary purposes only, internal and external technologies such as, modems including regular telephone grade modems, cable modems and DSL modems, ISDN adapters, and Ethernet cards.

FIG. 8 illustrates a flow diagram of an example, non-limiting operating environment in which one or more embodiments described herein can be facilitated.

Referring now to FIG. 8, there is illustrated a schematic block diagram of a computing environment 800 in accordance with this disclosure. The system 800 includes one or more client(s) 802 (e.g., laptops, smart phones, PDAs, media players, computers, portable electronic devices, tablets, and the like). The client(s) 802 can be hardware and/or software (e.g., threads, processes, computing devices). The system 800 also includes one or more server(s) 804. The server(s) 804 can also be hardware or hardware in combination with software (e.g., threads, processes, computing devices). The servers 804 can house threads to perform transformations by employing aspects of this disclosure, for example. One possible communication between a client 802 and a server 804 can be in the form of a data packet transmitted between two or more computer processes wherein the data packet may include video data. The data packet can include a metadata, e.g., associated contextual information, for example. The system 800 includes a communication framework 806 (e.g., a global communication network such as the Internet, or mobile network(s)) that can be employed to facilitate communications between the client(s) 802 and the server(s) 804.

Communications can be facilitated via a wired (including optical fiber) and/or wireless technology. The client(s) 802 include or are operatively connected to one or more client data store(s) 808 that can be employed to store information local to the client(s) 802 (e.g., associated contextual information). Similarly, the server(s) 804 are operatively include or are operatively connected to one or more server data store(s) 810 that can be employed to store information local to the servers 804. In one embodiment, a client 802 can transfer an encoded file, in accordance with the disclosed subject matter, to server 804. Server 804 can store the file, decode the file, or transmit the file to another client 802. It is to be appreciated, that a client 802 can also transfer uncompressed file to a server 804 and server 804 can compress the file in accordance with the disclosed subject matter. Likewise, server 804 can encode video information and transmit the information via communication framework 806 to one or more clients 802.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. An automated delivery system comprising:
an ordering module configured to receive, via one or more processor, delivery orders corresponding to an order identifier;
a fulfillment module configured to assign, via the one or more processor, delivery fulfillment data to the order identifier, wherein the delivery fulfillment data comprises at least one of a customer name, customer delivery address, destination location coordinates, or customer contact information;
a route generation module configured to generate, via the one or more processor; a delivery route for a set of customer orders that satisfies a minimal threshold travel time;
a procurement module configured to generate, via the one or more processor, a set of target packages corresponding to the set of customer orders for storage within a portable smart locker bank; and
a route implementation module configured to provision, via the one or more processor, the delivery route for an autonomous chassis configured to receive the portable smart locker bank.

2. The automated delivery system of claim 1, further comprising:
an unlocking module configured to unlock a smart locker compartment locking mechanism based on:
authenticating, by the one or more processor, a smart device corresponding to the order identifier; and
matching, by the one or more processor, a current coordinate of the autonomous chassis with the destination location coordinates.

3. The automated delivery system of claim 1, further comprising:
a driving module configured to command, via the one or more processor, the autonomous chassis to drive to another delivery location based upon an occurrence of an opening and a closing of the smart locker compartment.

4. The automated delivery system of claim 1, further comprising:
an integration module configured to provision, by the one or more processor, a set of delivery route instructions and order fulfillment instructions to any of a set of different autonomous vehicles configured with at least one or more smart locker compartment.

5. The automated delivery system of claim 2, further comprising:
a notification module configured to notify, by the one or more processor, an authenticated smart device, or alternative device corresponding with the authenticated device of an arrival of the autonomous chassis based on the matching the current coordinate with the destination location coordinates.

6. A method of loading an automated delivery vehicle comprising:
protracting, by an automated delivery vehicle configured to receive one or more smart locker bank, a set of guide rails connected to a chassis of the automated delivery vehicle in a lateral direction towards a palette holding a smart locker bank;
attaching, by the set of guide rails, to the palette via a latching mechanism;
retracting, by the automated delivery vehicle, the set of guide rails attached to the palette; and
securing, by the automated delivery vehicle, the bank of smart lockers on the chassis of the automated delivery vehicle.

7. The method of claim 6, wherein the smart locker bank stores packages within a set of compartments of the smart locker bank.

8. An automated package delivery vehicle device comprising:
a chassis component connected to a set of moveable guide rails, wherein the chassis component is configured to receive and hold one or more smart locker bank;
a set of wheels connected to the chassis component via a set of axles;
a tractor portion connected to a front portion of the chassis portion, wherein the tractor portion is configured to move the automated package delivery vehicle, and wherein the tractor portion is connected to an engine portion.

9. A method comprising:
synching, by a server device comprising one or more processor and communicatively coupled to a smart locker bank, the smart locker bank with an autonomous vehicle chassis based on an interlocking interaction between the smart locker device and the autonomous vehicle chassis;
generating, by the server device, an access code corresponding to an order identifier and customer zip code associated with locker compartments of the smart locker bank;
instructing, by the server device, the autonomous vehicle chassis to autonomously drive along a pre-defined route corresponding to customer addresses associated with the locker compartments;
monitoring, by the server device, a location of the autonomous vehicle chassis;
matching, by the server device, a current location of the autonomous vehicle chassis to coordinates of a customer destination;
notifying, by the server device, a client smart device of current location of the autonomous vehicle chassis to coordinates of a customer destination; and
automatically unlocking, by the server device, one or more smart locker compartment based on authentication of the client smart device via access code verification and based on the matching the current coordinates to the customer destination.
